(19) United States
(12) Patent Application Publication
(10) Pub. No.: US 2022/0410300 A1
(43) Pub. Date: Dec. 29, 2022

(54) METHOD AND APPARATUS FOR WELDING A WELD SEAM

(71) Applicant: Fronius International GmbH, Pettenbach (AT)

(72) Inventors: Andreas Waldhör, Pettenbach (AT); Martin Willinger, Pettenbach (AT)

(21) Appl. No.: 17/755,488

(22) PCT Filed: Oct. 30, 2020
(86) PCT No.: PCT/EP2020/080590

§ 371 Date: Apr. 29, 2022

(30) Foreign Application Priority Data
Nov. 4, 2019 (EP) 19206966.4

(51) Int. Cl. B23K 9/095; B23K 9/02; B23K 9/12

(52) U.S. Cl. CPC B23K 9/095; B23K 9/02; B23K 9/125

(57) ABSTRACT

Welding A welding apparatus is provided for welding a weld seam, in particular a root weld seam, with a reversing welding wire the advancing rate, V_{D}, of which is automatically reduced to a specified minimum rate value, V_{Dmin}, by a controller of the welding apparatus if no short-circuit, KS, is detected during an arcing phase within a specific time period, Δt, or within a specific extension, Δs, of the welding wire.

### PRIORITY CLAIM

This application is a 35 U.S.C. § 371 National Stage Application of PCT/EP2020/080590, filed on Oct. 30, 2020, which claims the benefit of priority to Ser. No. 19/206,966.4, filed on Nov. 4, 2019, in Europe, the disclosures of which are incorporated herein by reference in their entirety.

### TECHNICAL FIELD

The invention relates to a method and an apparatus for welding a weld seam with a reversing welding wire or welding wire electrode.

### TECHNICAL BACKGROUND

The CMT welding method (CMT: Cold Metal Transfer) is a metal inert gas welding method with a reversing welding wire electrode. In the case of the CMT welding process, the welding wire, to which electric voltage is applied, is moved in the direction of the workpiece until a short-circuit is formed. The welding wire is then moved back in the opposite direction. By reason of the wire movement, the welding beads can become detached from the welding wire when the short-circuit occurs, and so fewer spatters are produced during the welding process. By reason of the regulated current supply and the helpful effect of the wire movement of the welding wire during the material transfer, there is also a low heat input on the base material.

However, during root welding with larger gaps the situation can arise that the welding wire penetrates the weld pool when the advancing rate remains constant. This can occur in particular if the wire advancing rate of the welding wire is still relatively high, and so the welding wire penetrates the weld pool in the forwards movement towards the weld pool and thus no short-circuit can be detected. In conventional CMT welding processes, there are only two advancing phases in the arc phase. During a boost current, the welding wire has a specific advancing rate which is reduced during a subsequent short-circuit waiting phase until a short-circuit occurs. However, in the case of root welding there is the risk of the weld pool being penetrated by the welding wire and consequently no short-circuit can be detected. Penetration of the weld pool results in the arc being extinguished. The undesired penetration of the weld pool thus results in a considerable deterioration in the quality of the weld seam produced, because unmelted welding wire protrudes on the underside of the root.

There is a need to provide a method and an apparatus for welding a weld seam having increased weld seam quality.

### SUMMARY OF THE INVENTION

Accordingly, the invention provides an arc welding method for welding a weld seam with a reversing welding wire, the advancing rate of which is automatically reduced to a specified minimum rate value if no short-circuit is detected during an arcing phase within a specific time period or within a specific extension of the welding wire.

The arc welding method in accordance with the invention prevents, in particular, penetration of a weld pool by the welding wire in the case of larger gaps, in particular during production of a root weld seam.

In one possible embodiment of the arc welding method in accordance with the invention, the advancing rate of the welding wire is reduced in stages or continuously to a specified minimum rate value as soon as no short-circuit is detected within the specific time period or within the specific extension.

In a further possible embodiment of the arc welding method in accordance with the invention, the welding voltage is monitored and a short-circuit is automatically detected if there is a drop in the welding voltage.

In a further possible embodiment of the arc welding method in accordance with the invention, the welding current is reduced to a specified minimum current value in parallel with the reduction of the advancing rate of the welding wire.

In a further possible embodiment of the arc welding method in accordance with the invention, the welding wire, after its advancing rate has been reduced to the specified minimum rate value, is moved during the arcing phase with a positive advancing movement in the direction of the workpiece to be welded, until a short-circuit is detected.

In a further possible embodiment of the arc welding method in accordance with the invention, after detection of the short-circuit, the welding wire is moved back in the opposite direction at a negative advancing rate away from the workpieces to be welded.

In an alternative embodiment of the arc welding method in accordance with the invention, after detection of the short-circuit, the welding wire is moved further at a reduced positive advancing rate towards the workpieces to be welded.

In a further possible embodiment of the arc welding method in accordance with the invention, the minimum rate value of the advancing rate of the welding wire and/or the minimum current value of the welding current are set according to a stored characteristic curve.

In a further possible embodiment of the arc welding method in accordance with the invention, the advancing rate of the welding wire and/or the welding current is/are reduced in stages or continuously according to a stored characteristic curve as soon as no short-circuit is detected within the specific time period and/or the specific extension.

In a further possible embodiment of the arc welding method in accordance with the invention, different characteristic curves for reducing the advancing rate of the welding wire and/or for reducing the welding current are provided for different welding parameters.

In a further possible embodiment of the arc welding method in accordance with the invention, the welding parameters include in particular a material and/or a diameter of the welding wire, a type of inert gas used and a type of welding method selected.

In a further possible embodiment of the arc welding method in accordance with the invention, the minimum rate value of the advancing rate of the welding wire is between 0.1 and 5.0 m/min.

In a further preferred embodiment of the arc welding method in accordance with the invention, the minimum rate value of the advancing rate of the welding wire is in a range between 0.5 and 3.0 m/min.

In a further possible embodiment of the arc welding method in accordance with the invention, the minimum rate value of the advancing rate of the welding wire is about 1 m/min.

In a further possible embodiment of the arc welding method in accordance with the invention, the minimum current value of the welding current is between 0 amps and 200 amps.

In a preferred embodiment of the arc welding method in accordance with the invention, the minimum current value of the welding current is in a range between 0 amps to 50 amps, preferably about 20 amps.

According to a further aspect, the invention further provides a welding apparatus having the features stated in claim 13.

Accordingly, the invention provides a welding apparatus for welding a weld seam, in particular a root weld seam, with a reversing welding wire, the advancing rate of which is automatically reduced to a specified minimum rate value by a controller of the welding apparatus if no short-circuit is detected during an arcing phase within a specific time period or within a specific extension of the welding wire.

In one possible embodiment of the welding apparatus in accordance with the invention, the advancing rate of the welding wire and/or the welding current is/are reduced in stages or continuously according to a characteristic curve stored in a data memory of the welding apparatus if no short-circuit is detected by a detection device of the welding apparatus within a specific time period measured by a measuring device of the welding apparatus or within a specific extension of the welding wire measured by a measuring device of the welding apparatus.

In a further possible embodiment of the welding apparatus in accordance with the invention, the characteristic curves stored in the data memory are downloaded from a database.

Possible embodiments of the arc welding method in accordance with the invention and the welding apparatus in accordance with the invention will be explained in greater detail hereinafter with reference to the enclosed figures.

### DESCRIPTION OF THE DRAWINGS

In the drawing:

FIG. 1 shows one possible exemplified embodiment of a welding apparatus in accordance with the invention for welding a weld seam;

FIG. 2 shows a block diagram for illustrating an embodiment of the welding apparatus in accordance with the invention for welding a weld seam;

FIG. 3 shows signal diagrams for explaining the mode of operation of the arc welding method in accordance with the invention and the welding apparatus in accordance with the invention.

### DETAILED DESCRIPTION OF EMBODIMENTS

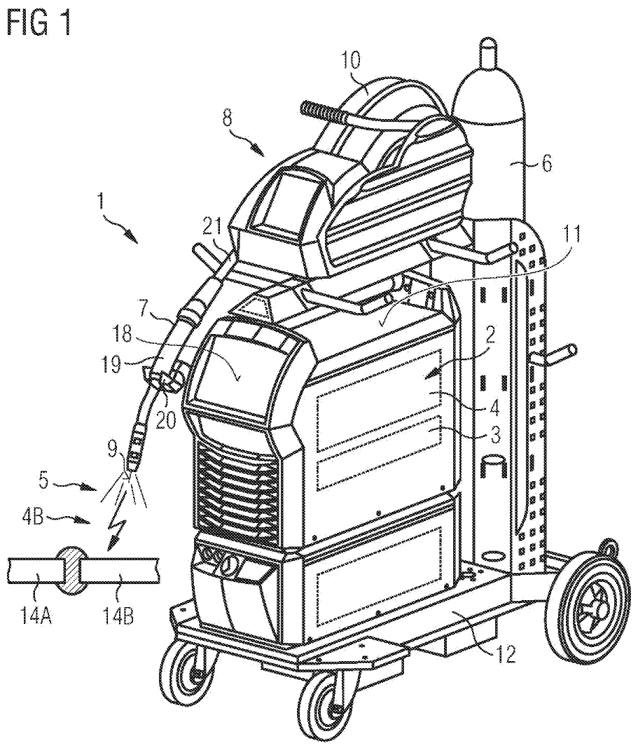

FIG. 1 shows an exemplified embodiment of a welding apparatus 1 in accordance with the invention for welding a weld seam. As can be seen in FIG. 1, the welding apparatus 1 comprises a current source 2 with a power section 3 provided therein. The welding apparatus 1 has a controller 4 which is provided for the purpose of regulating welding parameters P. These welding parameters P include e.g., a welding current I and an advancing rate V_{D} of a welding wire 9. This welding wire 9 comprises a melting welding wire electrode. The control device 4 can be connected e.g., to a control valve which is arranged in a supply line for an inert gas 5 between a gas storage tank 6 and a welding torch 7. The controller 4 activates a device 8 for delivering the melting welding wire electrode 9. In this case, the welding wire 9 can be supplied to the welding apparatus 1 from a supply drum 10 in the welding torch 7 via a supply line. The delivering device 8 can be integrated in a housing 11 of the current source 2 or, as shown in FIG. 1, can be positioned in an auxiliary device on a trolley 12.

The direct current I for establishing an arc 13, as shown in FIG. 1, is supplied to the welding wire electrode 9 via a welding line in the power section 3 of the current source 2. The arc 13 exists between the welding wire and the workpieces 14A, 14B, as illustrated schematically in FIG. 1. In the example shown in FIG. 1, two workpieces 14A, 14B are welded together. For example, workpieces 14A, 14B are welded together at the end faces. There is a gap between the end faces of the two workpieces 14A, 14B, in which a weld pool is produced. The welding apparatus 1 prevents the welding wire electrode 9 from penetrating the weld pool between the end faces of the two workpieces 14A, 14B. The welding apparatus 1 illustrated in FIG. 1 is thus suitable for producing a root weld seam.

In one embodiment, the current source 2 has a user interface or input and output apparatus 18, via which different welding parameters P, operating modes or welding programmes can be set. The controller 4 of the apparatus 1 activates components of the welding apparatus 1 in dependence upon the set welding parameters P, operating data and welding programmes. When using a corresponding welding torch 7, setting procedures can also be performed at this location. The welding torch 7 can be equipped with a separate welding torch input and output apparatus 19. In one possible embodiment, the welding torch 7 is connected via a data bus to the current source 2, in particular to the controller 4 integrated therein, and to the delivering apparatus 8 for delivering the welding wire 9. The welding torch 7 is connected to the current source 2 of the welding apparatus 1 via a hose assembly 21. Various lines, in particular supply lines for the welding wire electrode 9, for the inert gas 5, for the cooling circuit and for data transmission lines are provided in the hose assembly 21.

The welding wire 9 of the welding apparatus 1 is designed to be reversible, i.e., it can be moved both with a forwards movement in the direction towards the workpieces 14 and with a backwards movement away from the workpieces 14. The advancing rate V_{D} of the welding wire 9 is controlled by the controller 4 of the welding apparatus 1. The advancing rate V_{D} of the welding wire 9 is automatically reduced to a specified minimum rate value v_{Dmin} by the controller 4 of the welding apparatus 1 if no short-circuit KS is detected during an arcing phase LBBP within a specific time period Δt or within a specific extension Δs of the welding wire 9. The advancing rate V_{D} of the welding wire 9 and/or the welding current I is/are reduced in stages or continuously according to a characteristic curve KL stored in a data memory 22 of the welding apparatus 1 if no short-circuit KS is detected by a detection device of the welding apparatus 1 within a specific time period Δt measured by a measuring device 23 of the welding apparatus 1 or within a specific extension Δs of the welding wire 9 measured by a measuring device 23 of the welding apparatus 1. The measuring device 23 is preferably also able to detect a short-circuit KS, e.g., by means of the monitored welding voltage U. If the welding voltage U drops, a short-circuit KS is detected by the measuring device 23.

In one possible embodiment, the characteristic curves KL stored in the data memory 22 of the welding apparatus 1 can be downloaded from a database. For this purpose, in one possible embodiment the welding device 1 has a data interface which is connected to a remote server via a data network in order to download characteristic curves KL stored by a platform or database to the local data memory 22 of the welding apparatus 1.

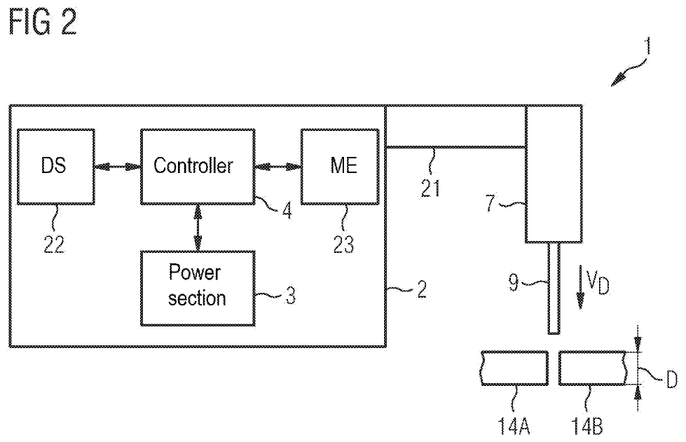

FIG. 2 schematically shows components of the welding apparatus 1 in accordance with the invention. A welding torch 7 is connected to the current source 2 of the welding apparatus 1 via a hose assembly 21. Located in the housing of the current source 2 is preferably the controller 4 with a power section 3. In the embodiment of the welding apparatus 1 illustrated schematically in FIG. 2, the controller 4 has access to a local data memory (DS) 22, in which one or more characteristic curves KL can be stored. Furthermore, measuring devices 23 are provided in the housing of the current source 2 in order to detect various parameters. The reversing welding wire 9 has an advancing rate V_{D} which can be controlled by the controller 4 of the welding apparatus 1. The advancing rate V_{D} of the welding wire 9 is automatically reduced to a specified minimum rate value v_{Dmin} by the controller 4 of the welding apparatus 1 if no short-circuit KS is detected by a corresponding measuring device 23 of the welding apparatus 1 during an arcing phase within a specific time period Δt or within a specific extension Δs of the welding wire 9.

In one possible embodiment, the advancing rate V_{D} of the welding wire 9 is reduced in stages to a specified minimum rate value v_{Dmin} by the controller 4 if no short-circuit KS is detected within the specific time period Δt or within the specific extension Δs. Alternatively, the advancing rate V_{D} of the welding wire 9 can also be reduced continuously to the specified minimum rate value v_{Dmin} by the controller 4 if no short-circuit KS is detected within the specific time period Δt or within the specific extension Δs. Preferably, the welding voltage U is monitored by a measuring device 23 of the welding apparatus 1. If the welding voltage U drops, a short-circuit KS is automatically detected. The reduction of the wire advancing rate V_{D} of the welding wire 9 can thus be effected either over a settable time cycle or over a defined extension.

In one possible embodiment of the welding apparatus in accordance with the invention, the welding current I is reduced to a specified minimum current value Iₘᵢₙ in parallel with the reduction of the advancing rate V_{D} of the welding wire 9. In one possible embodiment, the welding wire 9, after its advancing rate V_{D} has been reduced to the specified minimum rate value V_{Dmin}, is moved during the arcing phase with a positive advancing movement in the direction of the workpieces 14A, 14B to be welded, until a short-circuit KS is detected. After detection of the short-circuit KS, the welding wire 9 is then moved back in the opposite direction at a negative advancing rate V_{D} away from the workpieces 14A, 14B to be welded.

In one possible embodiment, both the minimum rate value of the advancing rate V_{Dmin} of the welding wire 9 and the minimum current value Iₘᵢₙ of the welding current are set according to a stored characteristic curve KL. This characteristic curve KL is preferably stored in a local data memory 22 of the current source 2. In one possible embodiment, the characteristic curves KL can be downloaded from a remote database to the local data memory 22 of the current source 2 via a data interface. In one possible embodiment, various characteristic curves KL for reducing the advancing rate V_{D} of the welding wire 9 and/or for reducing the welding current I are provided for different welding parameters P. In a further embodiment, a process regulator (not illustrate) of the current source 2 calculates, preferably by means of interpolation, on the basis of the set welding parameters SP, the characteristic curve points KL for reducing the advancing rate V_{D} of the welding wire 9 and/or for reducing the welding current I. These welding parameters P include, in particular, a material and/or a diameter of the welding wire 9, a type of inert gas 5 used and/or a type of welding method or welding operating mode selected by the user.

The minimum rate value of the advancing rate V_{Dmin} of the welding wire 9 can be calculated, configured or defined differently depending upon the application. In one possible embodiment, the minimum rate value of the advancing rate V_{D} of the welding wire 9 is between 0.1 m/min and 0.5 m/min. Preferably, the advancing rate V_{D} is 0.5 m/min to 3.0 m/min. In one possible embodiment, the minimum rate V_{Dmin} of the welding wire 9 is e.g., about 1 m/min. In one possible embodiment, the minimum current value Iₘᵢₙ of the welding current I is less than 200 amps, preferably in the range from 0 amps to 50 amps. In one possible embodiment, the minimum current value Iₘᵢₙ of the welding current I is e.g., about 20 amps.

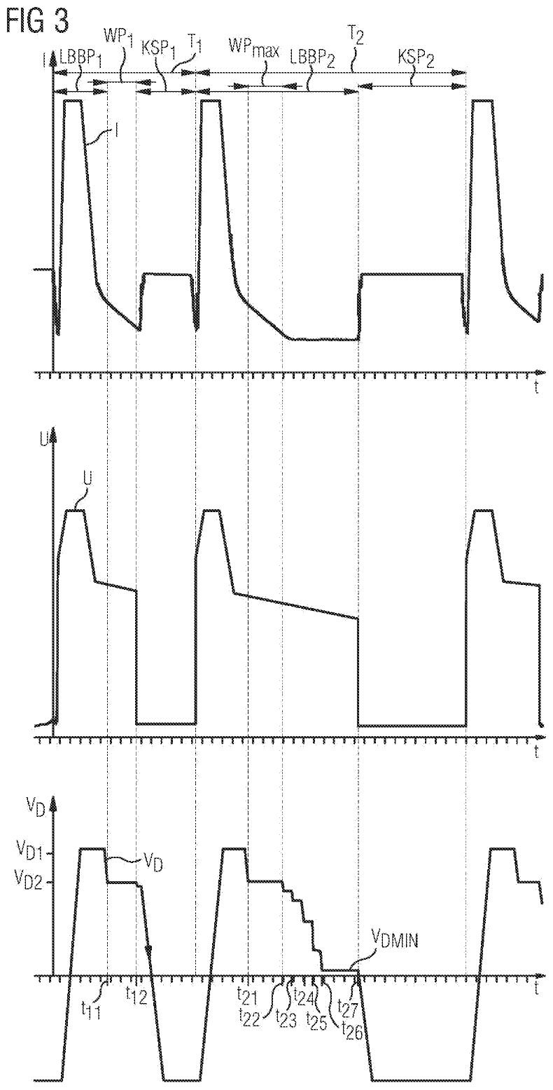

FIG. 3 shows a process sequence for explaining the mode of operation of the arc welding method in accordance with the invention and the welding apparatus 1 in accordance with the invention for welding a weld seam. FIG. 3 shows the time progression of a welding current I and a welding voltage U as well as an advancing rate V_{D} during an arc welding process. The arc welding process has an arcing phase LBBP and a short-circuit phase KSP which repeat periodically. In the arc welding process, the movement of the welding filler material or the welding wire electrode 9 is actively incorporated into the regulation of the welding process. Preferably, the welding wire 9 can be moved back and forth. During the arcing phase LBBP of the arc 13, the welding wire 9 is guided in the direction towards the workpiece 14 (V_{D}>0). The advancing rate V_{D} is reduced to the calculated, specified or pre-configured minimum rate value v_{Dmin} if no short-circuit KS is detected during the arcing phase LBBP within a specific specified time period Δt or within a specific specified extension Δs of the welding wire 9. In one possible embodiment, the reduction of the advancing rate V_{D} is effected via a settable time cycle T. As can be seen in FIG. 3, during an arcing phase LBBP, the welding wire 9 can be moved forwards at a positive advancing rate V_{D}. The advancing rate V_{D} of the welding wire 9 can be reduced from a high rate level V_{D1} to a slightly lower level V_{D2} after a certain time duration at time t₁₁, wherein there is then a waiting phase WP to establish whether a short-circuit KS is detected or not. The time t₁₁ marks the beginning of the short-circuit waiting phase WP. In the example illustrated in FIG. 3, a short circuit KS is detected to have occurred during the first time cycle T1 within the designated maximum waiting time at time t₁₂. In the example illustrated in FIG. 3, the monitored welding voltage U drops at time t₁₂ during the waiting phase WP and the voltage drop can be used to automatically detect that a short-circuit KS has occurred. The wire advancing rate V_{D} of the welding wire 9 is automatically rapidly reduced further from the rate level V_{D2} after the time t₁₂ as a result of the detected short-circuit KS and assumes a negative value (V_{D}<0), i.e. the welding wire electrode 9 is moved away from the workpiece 14.

In the second time cycle T2 illustrated in FIG. 3, there is no drop in the monitored welding voltage U during the predefined maximum waiting phase WPₘₐₓ. The waiting phase WP₂ in the second time cycle T2 begins at time t₂₁ when the advancing rate value V_{D} is lowered starting from the rate level V_{D1} to the rate level V_{D2}. The waiting phase WP in the second time cycle T2 ends after expiry of a specified maximum waiting time duration at time t₂₂. The advancing rate V_{D} of the welding wire 9 is automatically further reduced in stages at times t₂₃, t₂₄, t₂₅, t₂₆ during the arcing phase LBBP after expiry of the waiting time or maximum waiting phase WPₘₐₓ at time t₂₂, as illustrated in FIG. 3, in particular in order to prevent further penetration of a weld pool in the gap present between the workpieces 14A, 14B. As can be seen in FIG. 3, the wire advancing rate V_{D} is reduced in a plurality of stages or steps until a specified minimum rate value V_{Dmin} is achieved at time t₂₆. At this low advancing rate V_{Dmin}, the welding wire 9 is moved further until finally the short-circuit KS is detected at time t₂₇. As soon as the short-circuit KS has been detected, the welding wire 9 is moved preferably at a negative advancing rate V_{D}, i.e., in the opposite direction away from the workpieces 14A, 14B. The welding droplet formed in the arcing phase LBBP becomes detached. In order to prevent rapid penetration of the weld pool with the welding wire 9, in particular when producing a root weld seam, in the case of the arc welding method in accordance with the invention the wire advancement is reduced in steps in the short-circuit waiting phase KSP. In order to prevent the welding wire 9 from melting too far in the direction of the contact tube, a minimum rate V_{Dmin} is preferably defined. In one possible embodiment, the welding current I is reduced and limited in steps in parallel in order to ensure controlled melting of the welding wire electrode 9. By means of the arc welding method in accordance with the invention, the quality of the weld seam produced is increased. The arc welding method in accordance with the invention is particularly suitable for producing a root weld seam. In single-layer butt joint welding, the root of the weld seam is on the side which is not accessible to the welder.

In the welding apparatus 1 in accordance with the invention, in one possible embodiment, the instantaneously set characteristic curve KL can be displayed to the welder via the advancing rate V_{D} on a display of a user interface 18 of the current source 2. In one possible embodiment, the user interface 18 of the current source 2 has a touch screen which can be operated by the welder in order to change the characteristic curve KL. For example, in one possible embodiment the welder can adapt the characteristic curve KL illustrated in FIG. 3 to reduce the wire advancing rate in stages via the user interface 18. For different embodiment variants of the welding apparatus 1 in accordance with the invention, different measuring devices 23 can be used for measuring the extension Δs of the welding wire 9 and/or the time period Δt. In one possible embodiment, the extension Δs of the welding wire 9 can be calculated on the basis of a measured time period and the current progression of the advancing rate V_{D}. In a further possible embodiment, the extension Δs of the welding wire 9 can also be detected e.g., optically. In one possible embodiment, the extension Δs can be detected by means of an encoder of the wire advancing unit which forms a measuring unit. The encoder forms a signal transmitter. The encoder can be provided on the welding torch 7. Further embodiment variants for measuring the extension Δs are known to the person skilled in the art. The characteristic curve KL of the advancing rate V_{D} of the welding wire 9 and in particular the minimum rate V_{Dmin} can be set according to a thickness D of the workpieces 14A, 14B to be welded. In one possible embodiment, the welder inputs e.g., the thickness D of the sheets to be welded and a corresponding characteristic curve KL is used by the controller 4 to control the welding process. In a further possible embodiment, the process regulator (not illustrated) of the welding current source 2 calculates the characteristic curve operating points based on the existing welding parameters and creates the characteristic curve KL automatically. The arc welding method in accordance with the invention allows an almost currentless material transfer as well as controlled, clean and spatter-free droplet detachment. Furthermore, uncontrolled penetration of a weld pool in a larger gap between workpieces is prevented.

### LIST OF REFERENCE SIGNS

1 welding apparatus
2 current source
3 power section
4 controller
5 inert gas
6 gas storage tank
7 welding torch
8 delivering device
9 weld seam
10 storage drum
11 current source housing
12 trolley
LB arc
14 workpieces
18 user interface
19 welding torch input and output apparatus
20 heat protection shield
21 hose assembly
22 data memory
23 measuring device

1. Arc welding method for welding a weld seam with a reversing welding wire, the advancing rate, V_{D}, of which is automatically reduced to a specified minimum rate value, V_{Dmin}, if no short-circuit, KS, is detected during an arcing phase within a specific time period, Δt, or within a specific extension, Δs, of the welding wire.

2. Arc welding method as claimed in claim 1, wherein the advancing rate, V_{D}, of the welding wire is reduced in stages or continuously to the specified minimum rate value, v_{Dmin}, as soon as no short-circuit, KS, is detected within the specific time period, Δt, or within the specific extension, Δs.

3. Arc welding method as claimed in claim 1, wherein the welding voltage, U, is monitored and a short-circuit, KS, is detected as the welding voltage, U, drops.

4. Arc welding method as claimed in claim 1, wherein the welding current, I, is reduced to a specified minimum current value, Iₘᵢₙ, in parallel with the reduction of the advancing rate, V_{D}, of the welding wire.

5. Arc welding method as claimed in claim 1, wherein the welding wire, after its advancing rate, V_{D}, has been reduced to the specified minimum rate value, V_{Dmin}, is moved during the arcing phase with a positive advancing movement in the direction of the workpiece to be welded, until a short-circuit, KS, is detected.

6. Arc welding method as claimed in claim 5, wherein, after detection of the short-circuit, KS, the welding wire is moved back in the opposite direction at a negative advancing rate, V_{D}, away from the workpieces to be welded, or is moved further at a reduced advancing rate towards the workpieces to be welded.

7. Arc welding method as claimed in claim 4, wherein the minimum rate value of the advancing rate, V_{Dmin}, of the welding wire and/or the minimum current value, Iₘᵢₙ, of the welding current, I, are set according to a stored characteristic curve, KL.

8. Arc welding method as claimed in claim 1, wherein the advancing rate, V_{D}, of the welding wire and/or the welding current, I, are reduced in stages or continuously according to a stored characteristic curve, KL, as soon as no short-circuit, KS, is detected within the specific time period, Δt, and/or the specific extension, Δs.

9. Arc welding method as claimed in claim 8, wherein various characteristic curves, KL, for reducing the advancing rate, V_{D}, of the welding wire and/or for reducing the welding current, I, are provided for different welding parameters P.

10. Arc welding method as claimed in claim 9, wherein the welding parameters are selected from the group including a material and/or a diameter of the welding wire, a type of inert gas used and a type of welding method selected.

11. Arc welding method as claimed in claim 1, wherein the minimum rate value of the advancing rate, V_{D}, of the welding wire is between 0.1 m/min and 5.0 m/min, preferably in a range between 0.5 m/min and 3.0 m/min.

12. Arc welding method as claimed in claim 4, wherein the minimum current value, Iₘᵢₙ, of the welding current, I, is between 0 amps and 200 amps, preferably in a range between 0 amps to 50 amps.

13. Welding apparatus for welding a weld seam having a reversing welding wire, the advancing rate, V_{D}, of which is automatically reduced to a specified minimum rate value, v_{Dmin}, by a controller of the welding apparatus if no short-circuit, KS, is detected during an arcing phase within a specific time period, Δt, or within a specific extension, Δs, of the welding wire.

14. Welding apparatus as claimed in claim 13, wherein the advancing rate, V_{D}, of the welding wire and/or the welding current, I, is/are reduced in stages or continuously according to a characteristic curve, KL, stored in a data memory of the welding apparatus, if no short-circuit, KS, is detected by a measuring device of the welding apparatus within a specific time period, Δt, measured by a measuring device of the welding apparatus or within a specific extension, Δs, of the welding wire measured by a measuring device of the welding apparatus.

15. Welding apparatus as claimed in claim 14, wherein the characteristic curves, KL, stored in the data memory are downloaded from a database.
